(19) United States
(12) Patent Application Publication
(10) Pub. No.: US 2025/0227430 A1
(43) Pub. Date: Jul. 10, 2025

(54) AUDIO PLAYBACK METHOD AND DEVICE

(71) Applicant: BEIJING XIAOMI MOBILE SOFTWARE CO., LTD., Beijing (CN)

(72) Inventor: Shuo GAO, Beijing (CN)

(21) Appl. No.: 18/853,386

(22) PCT Filed: Apr. 6, 2022
(86) PCT No.: PCT/CN2022/085375

§ 371 Date: Oct. 1, 2024

(51) Int. Cl. H04S 7/00; H04R 3/12; H04R 5/02; H04S 3/00

(52) U.S. Cl. CPC H04S 7/303; H04R 3/12; H04R 5/02; H04S 3/008; H04R 2499/13; H04S 2400/01; H04S 2400/11

(57) ABSTRACT

An audio playback method includes: receiving, by a reception end, an audio stream from a transmission end, and decoding the audio stream to obtain a first audio signal decoded; and processing the first audio signal according to the N playback devices, to perform audio playback by the playback device.

### CROSS-REFERENCE TO RELATED APPLICATION

This application is a U.S. national phase of International Application No. PCT/CN2022/085375, filed Apr. 6, 2022, the entire content of which is incorporated herein by reference.

### TECHNICAL FIELD

The present disclosure relates to the field of communications technology, in particular to an audio playback method, and a device.

### BACKGROUND

With an increase in a demand on high-quality audio, audio playback of multi-channel sound and three-dimensional (3D) sound has been widely used.

### SUMMARY

In an aspect, the present disclosure provides in some embodiments an audio playback method for a reception end, including:
receiving an audio stream from a transmission end, and decoding the audio stream to obtain a first audio signal decoded; and
processing the first audio signal according to N playback devices, to perform audio playback by the playback device.

In another aspect, the present disclosure provides in some embodiments an audio playback method for a reception end, including:
obtaining a first audio signal from a reception end; and
processing the first audio signal according to the N playback devices, to perform audio playback by the playback device.

In another aspect, the present disclosure provides in some embodiments a receiving side device, N playback devices being arranged in a periphery of the receiving side device, where N is a positive integer, the receiving side device being configured to: receive an audio stream from a transmitting side device, and decode the audio stream to obtain a first audio signal decoded; and process the first audio signal in accordance with the N playback devices, to perform audio playback by the N playback devices.

### BRIEF DESCRIPTION OF THE DRAWINGS

The above-mentioned and/or other aspects and advantages of the present disclosure may become apparent and easily understandable in the following description in conjunction with the drawings.

FIG. 1a is a schematic view showing an audio playback method for a multi-channel format according to an embodiment of the present disclosure;

FIG. 1b is a schematic view showing an audio playback method using an external playback device according to an embodiment of the present disclosure;

FIG. 1c is a flow chart of an audio playback method according to an embodiment of the present disclosure;

FIGS. 1d to 1f are schematic view showing a distribution of playback devices in a vehicle body according to an embodiment of the present disclosure;

FIG. 2 is another flow chart of an audio playback method according to an embodiment of the present disclosure;

FIG. 3 is yet another flow chart of an audio playback method according to an embodiment of the present disclosure;

FIG. 4 is still yet another flow chart of an audio playback method according to an embodiment of the present disclosure;

FIG. 5 is still yet another flow chart of an audio playback method according to an embodiment of the present disclosure;

FIG. 6a is still yet another flow chart of an audio playback method according to an embodiment of the present disclosure;

FIG. 6b is still yet another flow chart of an audio playback method according to an embodiment of the present disclosure;

FIG. 7 is a flow chart of an audio playback method according to an embodiment of the present disclosure;

FIG. 8 is another flow chart of an audio playback method according to an embodiment of the present disclosure;

FIG. 9 is a schematic view showing an audio playback apparatus according to an embodiment of the present disclosure;

FIG. 10 is another schematic view showing an audio playback apparatus according to an embodiment of the present disclosure;

FIG. 11 is a block diagram of a user equipment according to an embodiment of the present disclosure; and

FIG. 12 is a block diagram of a network side device according to an embodiment of the present disclosure.

### DETAILED DESCRIPTION

The present disclosure will be described hereinafter in details in conjunction with illustrative embodiments, and examples thereof are shown in the drawings. Unless otherwise specified, identical numerals in different drawings represent identical or similar elements. The implementations in the following description do not include all implementations consistent with the embodiments of the present disclosure, and in contrast, they are merely examples of devices and methods consistent with some aspects of the embodiments of the present disclosure as specified in the appended claims.

The terms used in embodiments of the present disclosure are for illustrative purposes only, but do not intend to limit the present disclosure. Such a singular form as “an” or “the” used in the embodiments of the present disclosure and the appended claims also intends to include a plural form, unless otherwise defined. It should be appreciated that, the expression “and/or” used in the context is meant to include any combination, or all possible combinations, of one or more associated items.

It should be appreciated that, although such expressions as “first”, “second” and “third” are used to describe various information, the information are not limited by these expressions. These expressions are merely used to differentiate the information of a same type from each other. For example, without departing from the scope of the present disclosure, first information may also be called as second information, and similarly second information may also be called as first information. Depending on the context, such a word as “if” may be construed as “when . . . ”, “in a case that . . . ” or “in response to determining that . . . ”.

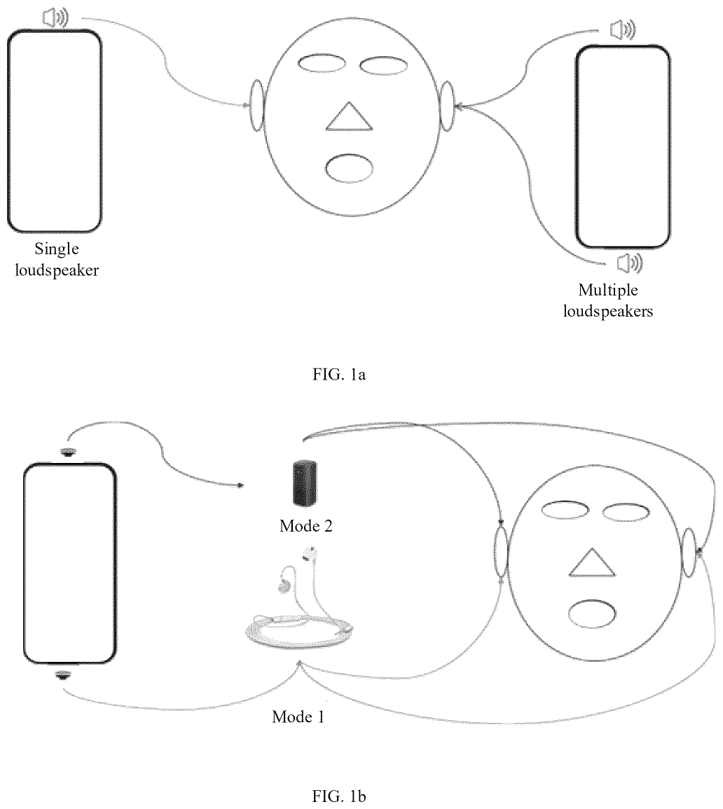

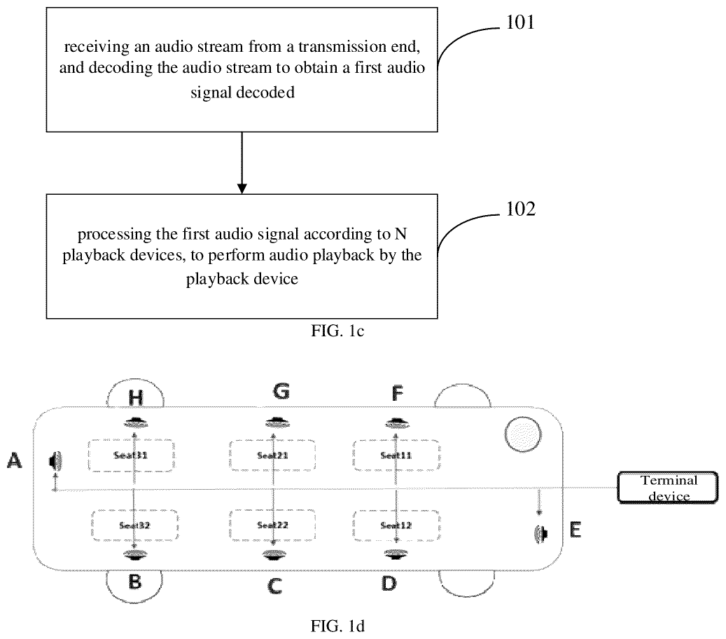

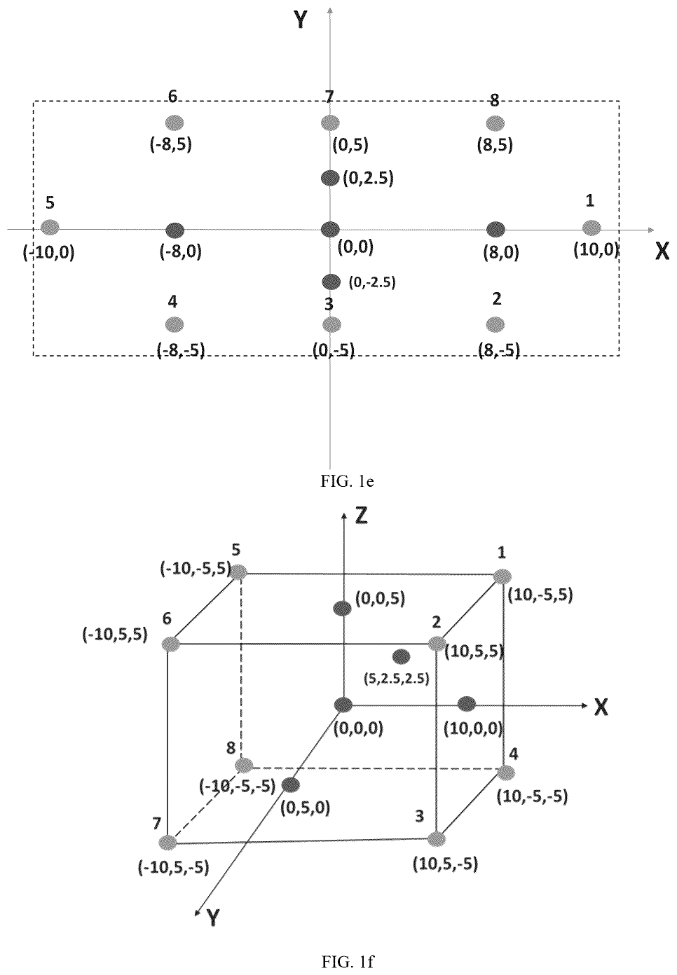

First method: FIG. 1a shows an audio playback method for a multi-channel format provided in an embodiment of the present disclosure. As shown in FIG. 1a, audio playback is performed directly by using a loudspeaker (for example, one or more loudspeakers, e.g., 2 or 3 loudspeakers) built in a terminal device such as a mobile phone.

Second method: the audio playback is performed by an external playback device. FIG. 1b shows an audio playback method using the external playback device provided in an embodiment of the present disclosure. As shown in FIG. 1b, the audio playback is performed by the external playback device in following two modes. In a first mode, the audio playback is performed by a loudspeaker of a wired headset. In a second mode, the audio playback is performed by a smart loudspeaker box.

However, the audio playback in the related art is limited by a playback device and a playback environment. To be specific, for the first method, it is impossible to playback high-quality 3D audio, resulting in that a listener cannot enjoy a high-quality, immersive audio experience. For the second method, the external playback device is limited by a distance, and it is impossible to playback a 3D audio signal, resulting in that an immersive audio service cannot be provided.

The present disclosure provides an audio playback method/apparatus/device, and a storage medium, to solve the technical problems that a conventional audio playback method cannot playback 3D audio and is limited by a distance.

An audio playback method/apparatus/device, and a storage medium provided in embodiments of the present disclosure will be described hereinafter in details with reference to the drawings.

FIG. 1c is a flow chart of an audio playback method according to embodiments of the present disclosure. The method is performed by a reception end. As shown in FIG. 1c, the audio playback method includes following steps.

Step 101, an audio stream is received from a transmission end, and the audio stream is decoded to obtain a decoded first audio signal.

In an embodiment of the present disclosure, N playback devices (e.g., loudspeakers) are arranged in a periphery of the reception end, where N is a positive integer. In an embodiment of the present disclosure, the reception end is in a vehicle. To be specific, the reception end is a vehicle-mounted communication device and/or a mobile terminal located in the vehicle (e.g., a mobile terminal (mobile phone or tablet computer) held by a person in the vehicle). Specifically, in an embodiment of the present disclosure, when the vehicle-mounted communication device is in the vehicle, the method in FIG. 1c may be executed by the vehicle-mounted communication device, and when no vehicle-mounted communication device is in the vehicle, the method in FIG. 1c may be executed by the mobile terminal in the vehicle.

In an embodiment of the present disclosure, the N playback devices are arranged on an inner wall of a vehicle body.

To be specific, FIGS. 1d to 1f are schematic views showing a distribution of the playback devices in the vehicle body according to embodiments of the present disclosure. As shown in FIG. 1d, eight playback devices A, B, C, D, E, F, G and H are arranged in the front, rear, left, and right of the vehicle. As shown in FIG. 1e, a dotted line represents a profile of the vehicle, the playback devices are arranged at locations indicated by light-colored dots, and the eight playback devices (i.e., 1, 2, 3, 4, 5, 6, 7 and 8) in the vehicle are located on a same horizontal plane. As shown in FIG. 1f, a cube represents a frame of the vehicle, the playback devices are arranged at locations indicated by light-colored dots, and the eight playback devices (i.e., 1, 2, 3, 4, 5, 6, 7 and 8) in the vehicle are arranged in a 3D manner.

In an embodiment of the present disclosure, the method of decoding the audio stream may be any conventional decoding method, a specific introduction of which may be reference to description of the prior arts.

In an embodiment of the present disclosure, the first audio signal is at least one of a single-channel signal, a stereo signal, an object signal, a multi-channel signal or a scene signal.

Step 102, the first audio signal is processed according to the N playback devices, to perform audio playback by the playback device.

A specific introduction of step 102 will be described in details in subsequent embodiments.

In a word, according to the audio playback method in embodiments of the present disclosure, first the reception end receives the audio stream from the transmission end, and decodes the audio stream so as to obtain the first audio signal. Next, the first audio signal is processed according to the decoded N playback devices, to perform the audio playback by the playback device. In embodiments of the present disclosure, the method “processing the first audio signal to perform the audio playback by the playback device” mainly includes: selecting N (N is a positive integer) playback devices according to a target location (i.e., a location where a listener is when the audio playback is performed); determining the second audio signals each corresponding to each of first playback devices according to the first audio signal and the second relative location information about the target location and each of the first playback device; and transmitting each of the second audio signals to the corresponding first playback device to perform the audio playback. Hence, in embodiments of the present disclosure, the audio signal is played back by a plurality of playback devices, which may perform audio playback in a 3D manner. Moreover, in embodiments of the present disclosure, the plurality of playback devices is in wireless communication with the reception end, then the audio playback is not limited by the distance. In addition, in embodiments of the present disclosure, to be specific, appropriate some playback devices are selected according to the second relative location information about the target location and each of the first playback devices, and then the audio playback is performed by an array of the selected playback devices, to perform accurately playback the audio signal at the target location, which may accurately playback the audio signal at the location where the listener is, thus improving user experiences.

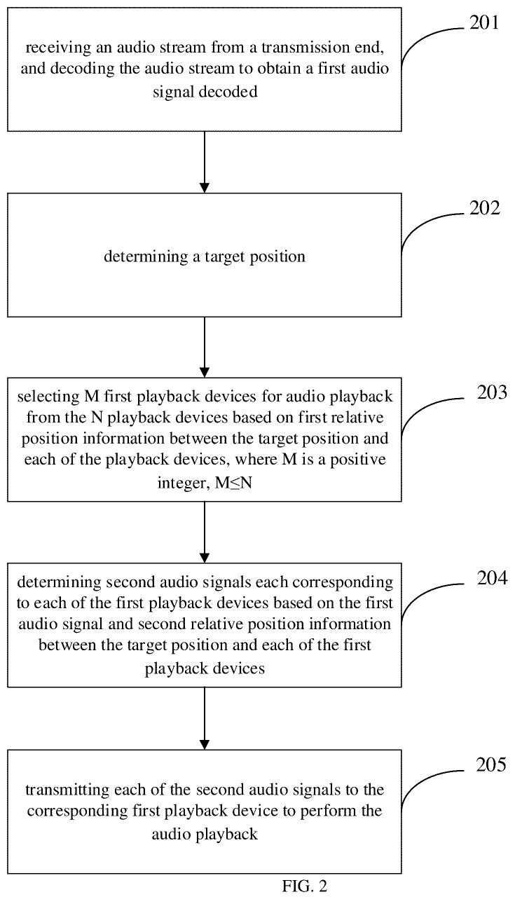

FIG. 2 is a flow chart of an audio playback method according to the embodiments of the present disclosure, and this method is executed by a reception end. As shown in FIG. 2, the audio playback method includes the following steps.

Step 201, an audio stream is received from a transmission end, and the audio stream is decoded to obtain a decoded first audio signal.

Step 201 may refer to that mentioned hereinabove, and thus will not be repeated herein.

Step 202: a target location is determined.

In an embodiment of the present disclosure, the target location is a location where a listener is when audio playback is performed. For example, the target location is a location corresponding to “seat” in FIG. 1d or any dark-colored dot in FIGS. 1e and 1f. For example, the target location is (−8, 0) in FIG. 1e or (0, 5, 0) in FIG. 1f.

In an embodiment of the present disclosure, for different reception ends, different methods are used to determine the target location. To be specific, when the reception end is a vehicle-mounted communication device, a predetermined target location is obtained, and the target location is any location in the vehicle (e.g., a location of a driver seat or a passenger seat). In other words, the target location is predetermined in the vehicle-mounted communication device, and when the vehicle-mounted communication device needs to determine the target location, it may directly obtain the predetermined target location without any positioning operation. In one embodiment of the present disclosure, the predetermined target location may be updated.

In another embodiment of the present disclosure, when the reception end is a mobile terminal in the vehicle, a location of the mobile terminal may be determined as the target location. For example, the location of the mobile terminal is determined by a Global Positioning System (GPS), or an infrared sensing technology.

Step 203: M first playback devices for audio playback are selected from the N playback devices according to first relative location information between the target location and each of the playback devices, where M is a positive integer, M≤N.

In an embodiment of the present disclosure, the first relative location information includes at least one of:
distance information between the target location and the playback device (e.g., the distance information is represented in form of coordinates between the target location and the playback device);
orientation angle information about the target location and the playback device, the orientation angle information including pitch angle information and/or azimuth angle information; or
information about an obstacle between the target location and the playback device (e.g., information about a rigid obstacle and/or information about a soft obstacle).

It should be appreciated that, in an embodiment of the present disclosure, location information about each playback device is pre-stored in the reception end. When the reception end needs to perform the audio playback, the distance information and the orientation angle information are determined directly according to the determined target location and the location information about each playback device. In an embodiment of the present disclosure, the information about the obstacle is detected by the reception end in real time.

Further, in an embodiment of the present disclosure, a criterion for selecting the M first playback devices from the N playback devices according to the first relative location information may mainly include at least one of:
preferentially selecting a playback device close to the target location as the first playback device;
preferentially selecting a playback device without any obstacle between the playback device and the target location as the first playback device;
preferentially selecting a playback device with a small orientation angle relative to the target location as the first playback device; or
ensuring that there is at least one first playback device in each direction for the target location.

Step 204: second audio signals each corresponding to each of the first playback devices is determined according to the first audio signal and second relative location information between the target location and each of the first playback devices.

In an embodiment of the present disclosure, the second relative location information includes at least one of:
distance information between the target location and the playback device; or
orientation angle information between the target location and the playback device, the orientation angle information including pitch angle information and/or azimuth angle information.

In other words, Yᵢ(t)=f(Y(t), ri, theta_i, phi_i), in which Yᵢ(t) represents a second audio signal corresponding to an i^{th} first playback device, Y(t) represents the first audio signal, ri represents distance information between the target location and the i^{th} first playback device, theta_i represents azimuth angle information between the target location and the i^{th} first playback device, and phi_i represents pitch angle information between the target location and the i^{th} first playback device.

It should be appreciated that, in an embodiment of the present disclosure, when types of the first audio signal are different, methods of determining the second audio signal are different.

To be specific, in an embodiment of the present disclosure, when the first audio signal is an object signal Y(t), the determining the second audio signals each corresponding to each of the first playback devices according to the object signal and the second relative location information between the target location and each of the first playback devices includes following steps.

Step a: a gain value Gain_x and a delay value Delay_x from the object signal Y(t) to each of the first playback devices are calculated according to the second relative location information between the target location and each of the first playback devices and a location of an object in metadata of the object signal Y(t).

Step b: the second audio signal Yi(t) corresponding to each of the first playback devices is determined by a first formula Yi(t)=Y(t-Delay_x)*Gain_x.

In another embodiment of the present disclosure, when the first audio signal is a multi-channel signal Y(t), determining the second audio signals each corresponding to each of the first playback devices according to the multi-channel signal Y(t) and the second relative location information between the target location and each of the first playback devices may include following steps.

Step 1: the M first playback devices are sequentially numbered.

Step 2: the quantity H of channels for the multi-channel signal Y(t) is determined.

Step 3: pieces of the second relative location information between the target location and the M first playback devices are ranked according to numbers of the first playback devices.

For example, in an embodiment of the present disclosure, when the first playback devices are numbered as first playback device 1, first playback device 2, first playback device 3, . . . , and first playback device M, the ranked second relative location information includes second relative location information between the target location and the first playback device 1, second relative location information between the target location and the first playback device 2, second relative location information between the target location and the first playback device 3, . . . , and second relative location information between the target location and the first playback device M.

Step 4: a transfer matrix is determined according to the ranked second relative location information, the quantity H of channels for the multi-channel signal Y(t) and a channel layout structure of the multi-channel signal Y(t). A size of the transfer matrix is H*M.

In an embodiment of the present disclosure, the transfer matrix is specifically used to transfer the multi-channel signal Y(t) into the second audio signals each corresponding to each of the first playback devices sequentially.

Step 5: the second audio signals each corresponding to each of the first playback devices are determined by a second formula [Y1(t), Y2(t), . . . , YM(t)]=Y(t)*transfer matrix, where Y1(t) represents the second audio signal corresponding to the first playback device 1, Y2(t) represents the second audio signal corresponding to the first playback device 2, . . . , and YM(t) represents the second audio signal corresponding to the first playback device M.

In yet another embodiment of the present disclosure, when the first audio signal is a scene signal Y(t), determining the second audio signals each corresponding to each of the first playback devices according to the scene signal Y(t) and the second relative location information between the target location and each of the first playback devices may include following steps.

Step 1: the M first playback devices sequentially are numbered.

Step 2: the quantity L+1 of channels for the scene signal Y(t) is determined.

Step 3: pieces of second relative location information between the target location and the M first playback devices are ranked according to numbers of the first playback devices.

Step 4: a transfer matrix is determined according to the ranked second relative location information, the quantity L+1 of channels for the scene signal Y(t) and a channel layout structure of the scene signal Y(t). A size of the transfer matrix is (L+1)*M.

Step 5: the second audio signals each corresponding to each of the first playback devices are determined by a second formula [Y1(t), Y2(t), . . . , YM(t)]=Y(t)*transfer matrix, where Y1(t) represents a second audio signal corresponding to a first playback device 1, Y2(t) represents a second audio signal corresponding to a first playback device 2, . . . , and YM(t) represents a second audio signal corresponding to a first playback device M.

Steps 1 to 5 may refer to those mentioned hereinabove, and thus will not be particularly defined herein.

The first audio signal is rendered through the above-mentioned Steps 202 to 204, so as to obtain the second audio signal corresponding to each first playback device.

Step 205: each of the second audio signals is transmitted to the corresponding first playback device to perform the audio playback.

In an embodiment of the present disclosure, the reception end transmits each of the second audio signals to the corresponding first playback device in a wireless or wired manner, and the audio playback is performed by an array of the M first playback devices.

On the basis of Steps 201 to 205, in embodiments of the present disclosure, upon the receipt of the audio stream from the transmission end, the reception end decodes the audio stream to obtain the first audio signal, selects the M first playback devices from the N playback devices surrounding the reception end, renders, through its processing module, the first audio signal using an audio signal processing algorithm through Steps 202 to 205 so as to obtain the second audio signal corresponding to each first playback device, and finally transmits the second audio signal to the corresponding first playback device to perform audio playback.

In a word, according to the audio playback method in embodiments of the present disclosure, first the reception end receives the audio stream from the transmission end, and decodes the audio stream so as to obtain the first audio signal. Next, the first audio signal is processed according to the decoded N playback devices, to perform the audio playback by the playback device. In embodiments of the present disclosure, the method “processing the first audio signal to perform the audio playback by the playback device” mainly includes: selecting N (N is a positive integer) playback devices according to a target location (i.e., a location where a listener is when the audio playback is performed); determining the second audio signals each corresponding to each of first playback devices according to the first audio signal and the second relative location information about the target location and each of the first playback device; and transmitting each of the second audio signals to the corresponding first playback device to perform the audio playback. Hence, in embodiments of the present disclosure, the audio signal is played back by a plurality of playback devices, which may perform audio playback in a 3D manner. Moreover, in embodiments of the present disclosure, the plurality of playback devices is in wireless communication with the reception end, then the audio playback is not limited by the distance. In addition, in embodiments of the present disclosure, to be specific, appropriate some playback devices are selected according to the second relative location information about the target location and each of the first playback devices, and then the audio playback is performed by an array of the selected playback devices, to perform accurately playback the audio signal at the target location, which may accurately playback the audio signal at the location where the listener is, thus improving user experiences.

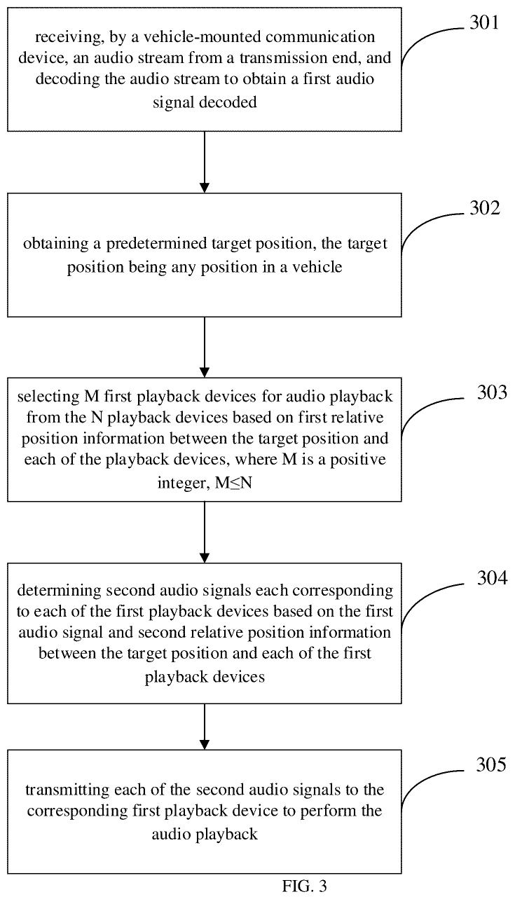

FIG. 3 is a flow chart of an audio playback apparatus according to embodiments of the present disclosure. The method is executed by a reception end which is a vehicle-mounted communication device. As shown in FIG. 3, the audio playback method includes following steps.

Step 301: the vehicle-mounted communication device receives an audio stream from a transmission end, and decodes the audio stream to obtain a decoded first audio signal.

Step 302: a predetermined target location is obtained, the target location being any location in a vehicle.

Step 303: M first playback devices for audio playback are selected from N playback devices according to first relative location information between the target location and each of the playback devices, M being a positive integer and M≤N.

Step 304: second audio signals each corresponding to each of the first playback devices are determined according to the first audio signal and second relative location information between the target location and the M first playback devices.

Step 305: each of the second audio signals are transmitted to the corresponding first playback device, to perform the audio playback.

Step 301 to 305 may refer to those mentioned hereinabove, and thus will not be repeated herein.

In a word, according to the audio playback method in the embodiments of the present disclosure, the reception end receives the audio stream from the transmission end, and decodes the audio stream so as to obtain the first audio signal. Next, the first audio signal is processed so as to perform audio playback through the playback devices. In the embodiments of the present disclosure, the processing the first audio signal so as to perform audio playback through the playback devices mainly includes: selecting the N (N is a positive integer) playback devices according to the target location (i.e., the location where the listener is when audio playback is performed); determining the second audio signal corresponding to each first playback device according to the first audio signal and the second relative location information between the target location and each first playback device; and transmitting each second audio signal to the corresponding first playback device according to the N playback devices to perform audio playback. Hence, in embodiments of the present disclosure, the audio signal is played back by a plurality of playback devices, which may perform audio playback in a 3D manner. Moreover, in embodiments of the present disclosure, the plurality of playback devices is in wireless communication with the reception end, then the audio playback is not limited by the distance. In addition, in embodiments of the present disclosure, to be specific, appropriate some playback devices are selected according to the second relative location information about the target location and each of the first playback devices, and then the audio playback is performed by an array of the selected playback devices, to perform accurately playback the audio signal at the target location, which may accurately playback the audio signal at the location where the listener is, thus improving user experiences.

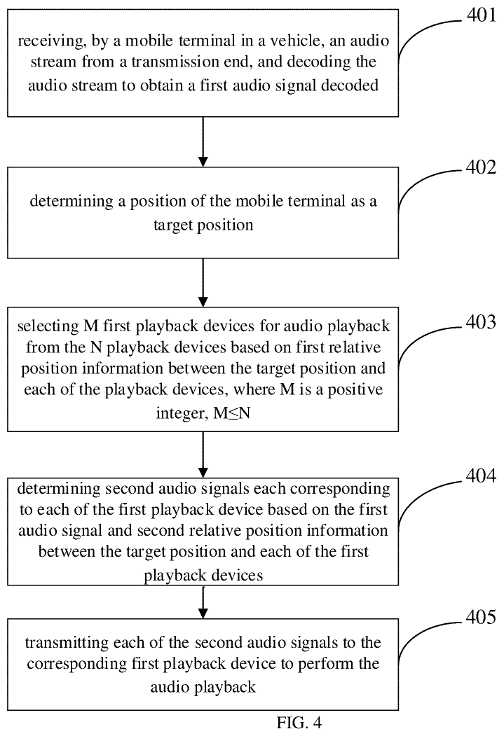

FIG. 4 is a flow chart of an audio playback method according to the embodiments of the present disclosure. The method is executed by a reception end which is a mobile terminal in a vehicle. As shown in FIG. 4, the audio playback method includes following steps.

Step 401: the mobile terminal in the vehicle receives an audio stream from a transmission end, and decodes the audio stream to obtain a decoded first audio signal.

Step 402: a location of the mobile terminal is determined as a target location.

Step 403: M first playback devices for audio playback are selected from N playback devices according to first relative location information between the target location and each of the playback devices, M being a positive integer and M≤N.

Step 404: second audio signals each corresponding to each of the first playback devices are determined according to the first audio signal and second relative location information between the target location and the M first playback devices.

Step 405: each of the second audio signals is transmitted to the corresponding first playback device, to perform the audio playback.

Step 401 to 405 may refer to those mentioned hereinabove, and thus will not be repeated herein.

In a word, according to the audio playback method in the embodiments of the present disclosure, the reception end receives the audio stream from the transmission end, and decodes the audio stream so as to obtain the first audio signal. Next, the first audio signal is processed according to the N playback devices so as to perform audio playback through the playback devices. In the embodiments of the present disclosure, the processing the first audio signal so as to perform audio playback through the playback devices mainly includes: selecting the N (N is a positive integer) playback devices according to the target location (i.e., the location where the listener is when audio playback is performed); determining the second audio signal corresponding to each first playback device according to the first audio signal and the second relative location information between the target location and each first playback device; and transmitting each second audio signal to the corresponding first playback device to perform audio playback. Hence, in embodiments of the present disclosure, the audio signal is played back by a plurality of playback devices, which may perform audio playback in a 3D manner. Moreover, in embodiments of the present disclosure, the plurality of playback devices is in wireless communication with the reception end, then the audio playback is not limited by the distance. In addition, in embodiments of the present disclosure, to be specific, appropriate some playback devices are selected according to the second relative location information about the target location and each of the first playback devices, and then the audio playback is performed by an array of the selected playback devices, to perform accurately playback the audio signal at the target location, which may accurately playback the audio signal at the location where the listener is, thus improving user experiences.

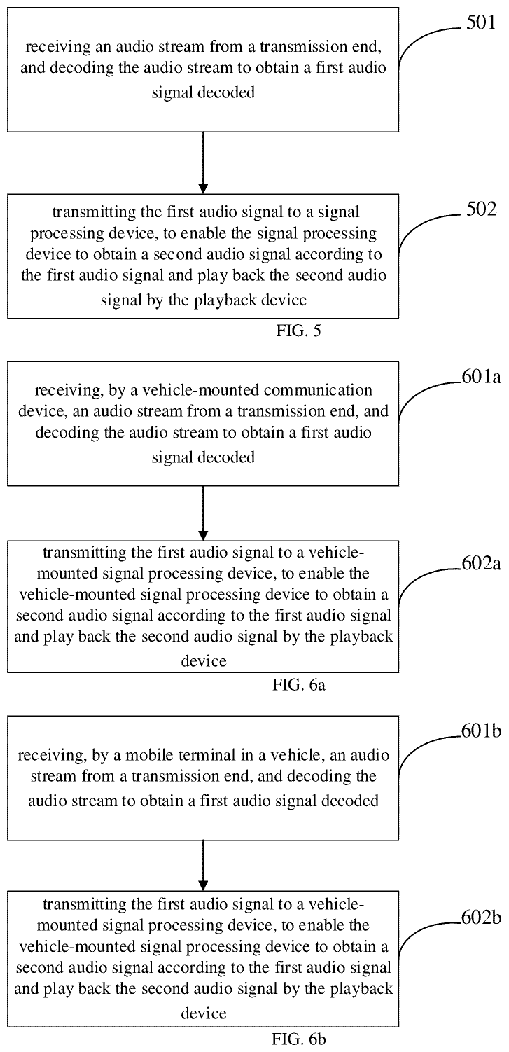

FIG. 5 is a flow chart of an audio playback method according to the embodiments of the present disclosure. The method is executed by a reception end. As shown in FIG. 5, the audio playback method includes following steps.

Step 501: an audio stream is received from a transmission end, and the audio stream is decoded to obtain a decoded first audio signal.

Step 502: the first audio signal is transmitted to a signal processing device, to enable the signal processing device to process the first audio signal according to N playback devices to obtain a second audio signal and to play back the second audio signal by the playback device.

In an embodiment of the present disclosure, the reception end transmits the first audio signal to the signal processing device in a wireless or wired manner.

In an embodiment of the present disclosure, the signal processing device obtains the second audio signal according to the first audio signal and plays back the second audio signal by the playback device using the above-mentioned steps 202 to 205, and the description thereof may refer to that mentioned hereinabove, which will not be repeated herein.

It should be appreciated that, in an embodiment of the present disclosure, after receiving the audio stream and decoding the audio stream to obtain the first audio signal, the reception end itself does not process the first audio signal, and instead it transmits the first audio signal to the signal processing device, so that the signal processing devices renders the first audio signal using an audio signal processing algorithm to obtain the second audio signal corresponding to each of the first playback devices, and transmits each of the second audio signals to the corresponding first playback device to perform the audio playback. For example, when the reception end does not have a signal processing capability (e.g., when the reception end is not provided with any signal processing module), the reception end transmits the first audio signal to the signal processing device for the subsequent processing.

When the reception end is in a vehicle, the signal processing device may be a vehicle-mounted signal processing device.

In a word, according to the audio playback method in the embodiments of the present disclosure, the reception end receives the audio stream from the transmission end, and decodes the audio stream so as to obtain the first audio signal. Next, the first audio signal is processed according to the N playback devices so as to perform audio playback through the playback devices. In the embodiments of the present disclosure, the processing the first audio signal so as to perform audio playback through the playback devices mainly includes: selecting the N (N is a positive integer) playback devices according to the target location (i.e., the location where the listener is when audio playback is performed); determining the second audio signal corresponding to each first playback device according to the first audio signal and the second relative location information between the target location and each first playback device; and transmitting each second audio signal to the corresponding first playback device to perform audio playback. Hence, in embodiments of the present disclosure, the audio signal is played back by a plurality of playback devices, which may perform audio playback in a 3D manner. Moreover, in embodiments of the present disclosure, the plurality of playback devices is in wireless communication with the reception end, then the audio playback is not limited by the distance. In addition, in embodiments of the present disclosure, to be specific, appropriate some playback devices are selected according to the second relative location information about the target location and each of the first playback devices, and then the audio playback is performed by an array of the selected playback devices, to perform accurately playback the audio signal at the target location, which may accurately playback the audio signal at the location where the listener is, thus improving user experiences.

FIG. 6a is a flow chart of an audio playback method according to the embodiments of the present disclosure, and this method is executed by a reception end. As shown in FIG. 6a, the audio playback method includes the following steps.

Step 601a: a vehicle-mounted communication device receives an audio stream from a transmission end, and decodes the audio stream to obtain a decoded first audio signal.

Step 602a: the first audio signal is transmitted to a vehicle-mounted signal processing device, to enable the vehicle-mounted signal processing device to obtain a second audio signal according to the first audio signal and play back the second audio signal by the playback device.

In a word, according to the audio playback method in the embodiments of the present disclosure, the reception end receives the audio stream from the transmission end, and decodes the audio stream so as to obtain the first audio signal. Next, the first audio signal is processed according to the N playback devices so as to perform audio playback through the playback devices. In the embodiments of the present disclosure, the processing the first audio signal so as to perform audio playback through the playback devices mainly includes: selecting the N (N is a positive integer) playback devices according to the target location (i.e., the location where the listener is when audio playback is performed); determining the second audio signal corresponding to each first playback device according to the first audio signal and the second relative location information between the target location and each first playback device; and transmitting each second audio signal to the corresponding first playback device to perform audio playback. Hence, in embodiments of the present disclosure, the audio signal is played back by a plurality of playback devices, which may perform audio playback in a 3D manner. Moreover, in embodiments of the present disclosure, the plurality of playback devices is in wireless communication with the reception end, then the audio playback is not limited by the distance. In addition, in embodiments of the present disclosure, to be specific, appropriate some playback devices are selected according to the second relative location information about the target location and each of the first playback devices, and then the audio playback is performed by an array of the selected playback devices, to perform accurately playback the audio signal at the target location, which may accurately playback the audio signal at the location where the listener is, thus improving user experiences.

FIG. 6b is a flow chart of an audio playback method according to the embodiments of the present disclosure. The method is executed by a reception end. As shown in FIG. 6b, the audio playback method includes following steps.

Step 601b: a mobile terminal in a vehicle receives an audio stream from a transmission end, and decodes the audio stream to obtain a decoded first audio signal.

Step 602bb: the first audio signal is transmitted to a vehicle-mounted signal processing device, to enable the vehicle-mounted signal processing device to obtain a second audio signal according to the first audio signal and play back the second audio signal by the playback device.

In a word, according to the audio playback method in the embodiments of the present disclosure, the reception end receives the audio stream from the transmission end, and decodes the audio stream so as to obtain the first audio signal. Next, the first audio signal is processed according to the N playback devices so as to perform audio playback through the playback devices. In the embodiments of the present disclosure, the processing the first audio signal so as to perform audio playback through the playback devices mainly includes: selecting the N (N is a positive integer) playback devices according to the target location (i.e., the location where the listener is when audio playback is performed); determining the second audio signal corresponding to each first playback device according to the first audio signal and the second relative location information between the target location and each first playback device; and transmitting each second audio signal to the corresponding first playback device to perform audio playback. Hence, in embodiments of the present disclosure, the audio signal is played back by a plurality of playback devices, which may perform audio playback in a 3D manner. Moreover, in embodiments of the present disclosure, the plurality of playback devices is in wireless communication with the reception end, then the audio playback is not limited by the distance. In addition, in embodiments of the present disclosure, to be specific, appropriate some playback devices are selected according to the second relative location information about the target location and each of the first playback devices, and then the audio playback is performed by an array of the selected playback devices, to perform accurately playback the audio signal at the target location, which may accurately playback the audio signal at the location where the listener is, thus improving user experiences.

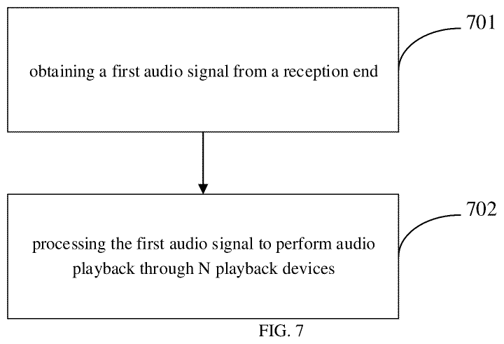

FIG. 7 is a flow chart of an audio playback method according to embodiments of the present disclosure. The method is executed by a signal processing device. As shown in FIG. 7, the audio playback method includes following steps.

Step 701: a first audio signal is obtained from a reception end.

Step 702: the first audio signal is processed according to N playback devices, to perform audio playback by the playback device.

In an embodiment of the present disclosure, the N playback devices are arranged in a peripheral of the signal processing device.

Steps 701 and 702 may refer to those mentioned hereinabove, and thus will not be repeated here.

In a word, according to the audio playback method in the embodiments of the present disclosure, the reception end receives the audio stream from the transmission end, and decodes the audio stream so as to obtain the first audio signal. Next, the first audio signal is processed according to the N playback devices so as to perform audio playback through the playback devices. In the embodiments of the present disclosure, the processing the first audio signal so as to perform audio playback through the playback devices mainly includes: selecting the N (N is a positive integer) playback devices according to the target location (i.e., the location where the listener is when audio playback is performed); determining the second audio signal corresponding to each first playback device according to the first audio signal and the second relative location information between the target location and each first playback device; and transmitting each second audio signal to the corresponding first playback device to perform audio playback. Hence, in embodiments of the present disclosure, the audio signal is played back by a plurality of playback devices, which may perform audio playback in a 3D manner. Moreover, in embodiments of the present disclosure, the plurality of playback devices is in wireless communication with the reception end, then the audio playback is not limited by the distance. In addition, in embodiments of the present disclosure, to be specific, appropriate some playback devices are selected according to the second relative location information about the target location and each of the first playback devices, and then the audio playback is performed by an array of the selected playback devices, to perform accurately playback the audio signal at the target location, which may accurately playback the audio signal at the location where the listener is, thus improving user experiences.

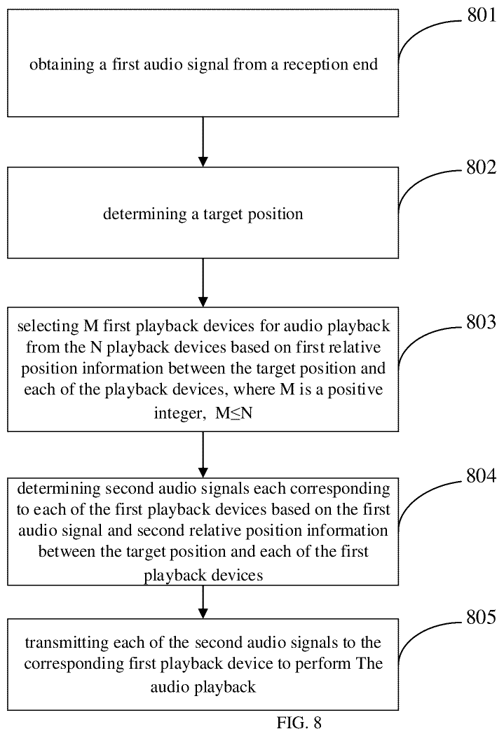

FIG. 8 is a flow chart of an audio playback method according to the embodiments of the present disclosure. The method is executed by a signal processing device. As shown in FIG. 8, the audio playback method includes following steps.

Step 801: a first audio signal is obtained from a reception end.

Step 802: a target location is determined.

In an embodiment of the present disclosure, the target location is a location where a listener is when audio playback is performed.

Step 803: M first playback devices for audio playback are selected from the N playback devices according to first relative location information between the target location and each of the playback devices, M being a positive integer and M≤N.

Step 804: second audio signals each corresponding to each of the first playback devices are determined according to the first audio signal and second relative location information between the target location and the M first playback devices.

Step 805: each of the second audio signals are transmitted to the corresponding first playback device to perform the audio playback.

Steps 801 to 805 may refer to those mentioned hereinabove, and thus will not be repeated herein.

In a word, according to the audio playback method in the embodiments of the present disclosure, the reception end receives the audio stream from the transmission end, and decodes the audio stream so as to obtain the first audio signal. Next, the first audio signal is processed according to the N playback devices so as to perform audio playback through the playback devices. In the embodiments of the present disclosure, the processing the first audio signal so as to perform audio playback through the playback devices mainly includes: selecting the N (N is a positive integer) playback devices according to the target location (i.e., the location where the listener is when audio playback is performed); determining the second audio signal corresponding to each first playback device according to the first audio signal and the second relative location information between the target location and each first playback device; and transmitting each second audio signal to the corresponding first playback device to perform audio playback. Hence, in embodiments of the present disclosure, the audio signal is played back by a plurality of playback devices, which may perform audio playback in a 3D manner. Moreover, in embodiments of the present disclosure, the plurality of playback devices is in wireless communication with the reception end, then the audio playback is not limited by the distance. In addition, in embodiments of the present disclosure, to be specific, appropriate some playback devices are selected according to the second relative location information about the target location and each of the first playback devices, and then the audio playback is performed by an array of the selected playback devices, to perform accurately playback the audio signal at the target location, which may accurately playback the audio signal at the location where the listener is, thus improving user experiences.

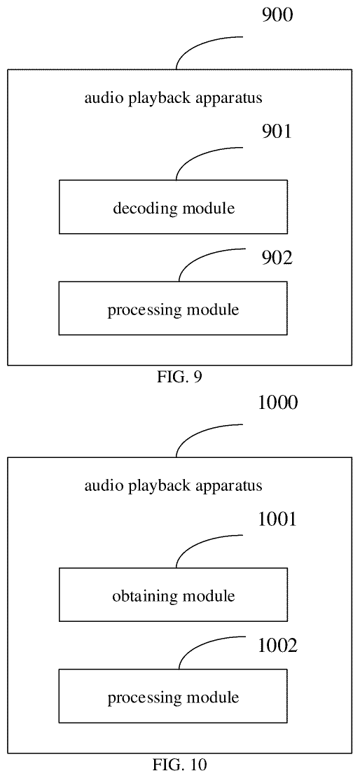

FIG. 9 is a schematic view showing an audio playback apparatus according to embodiments of the present disclosure. As shown in FIG. 9, the audio playback apparatus includes: a receiving module, configured to receive an audio stream from a transmission end, and decode the audio stream to obtain a decoded first audio signal; and
a processing module, configured to process the first audio signal according to N playback devices, to perform audio playback by the playback device.

In a word, according to the audio playback apparatus in the embodiments of the present disclosure, the reception end receives the audio stream from the transmission end, and decodes the audio stream so as to obtain the first audio signal. Next, the first audio signal is processed according to the N playback devices so as to perform audio playback through the playback devices. In the embodiments of the present disclosure, the processing the first audio signal so as to perform audio playback through the playback devices mainly includes: selecting the N (N is a positive integer) playback devices according to the target location (i.e., the location where the listener is when audio playback is performed); determining the second audio signal corresponding to each first playback device according to the first audio signal and the second relative location information between the target location and each first playback device; and transmitting each second audio signal to the corresponding first playback device to perform audio playback. Hence, in embodiments of the present disclosure, the audio signal is played back by a plurality of playback devices, which may perform audio playback in a 3D manner. Moreover, in embodiments of the present disclosure, the plurality of playback devices is in wireless communication with the reception end, then the audio playback is not limited by the distance. In addition, in embodiments of the present disclosure, to be specific, appropriate some playback devices are selected according to the second relative location information about the target location and each of the first playback devices, and then the audio playback is performed by an array of the selected playback devices, to perform accurately playback the audio signal at the target location, which may accurately playback the audio signal at the location where the listener is, thus improving user experiences.

Optionally, in an embodiment of the present disclosure, the processing module is further configured to:
determine a target location, the target location being a location where a listener is when the audio playback is performed;
select M first playback devices for audio playback from the N playback devices according to first relative location information between the target location and each of the playback devices, M being a positive integer and M≤N;
determine second audio signals each corresponding to each of the first playback devices according to the first audio signal and second relative location information between the target location and each of the first playback devices; and
transmit each of the second audio signals to the corresponding first playback device to perform the audio playback.

Optionally, in an embodiment of the present disclosure, the processing module is further configured to:
transmit the first audio signal to a signal processing device, to enable the signal processing device to process the first audio signal according to the N playback devices to obtain a second audio signal and play back the second audio signal by the playback device.

Optionally, in an embodiment of the present disclosure, the first relative location information includes at least one of:
distance information between the target location and the playback device;
orientation angle information between the target location and the playback device, the orientation angle information including pitch angle information and/or azimuth angle information; or
information about an obstacle between the target location and the playback device.

Optionally, in an embodiment of the present disclosure, the second relative location information includes at least one of:
distance information between the target location and the playback device; or
orientation angle information about the target location and the playback device, the orientation angle information including pitch angle information and/or azimuth angle information.

Optionally, in an embodiment of the present disclosure, the reception end is a vehicle-mounted communication device.

Optionally, in an embodiment of the present disclosure, the reception end is a mobile terminal in a vehicle.

Optionally, in an embodiment of the present disclosure, the processing module is further configured to:
obtain the target location predetermined, in which the target location is any location in the vehicle.

Optionally, in an embodiment of the present disclosure, the processing module is further configured to:
determine a location of the mobile terminal as the target location.

Optionally, in an embodiment of the present disclosure, the signal processing device is a vehicle-mounted signal processing device.

FIG. 10 is a schematic view showing an audio playback apparatus according to the embodiments of the present disclosure. As shown in FIG. 10, the audio playback apparatus includes:
an obtaining module, configured to obtain a first audio signal from a reception end; and
a processing module, configured to process the first audio signal to perform audio playback by the playback device.

In a word, according to the audio playback apparatus in the embodiments of the present disclosure, the reception end receives the audio stream from the transmission end, and decodes the audio stream so as to obtain the first audio signal. Next, the first audio signal is processed according to the N playback devices so as to perform audio playback through the playback devices. In the embodiments of the present disclosure, the processing the first audio signal so as to perform audio playback through the playback devices mainly includes: selecting the N (N is a positive integer) playback devices according to the target location (i.e., the location where the listener is when audio playback is performed); determining the second audio signal corresponding to each first playback device according to the first audio signal and the second relative location information between the target location and each first playback device; and transmitting each second audio signal to the corresponding first playback device to perform audio playback. Hence, in embodiments of the present disclosure, the audio signal is played back by a plurality of playback devices, which may perform audio playback in a 3D manner. Moreover, in embodiments of the present disclosure, the plurality of playback devices is in wireless communication with the reception end, then the audio playback is not limited by the distance. In addition, in embodiments of the present disclosure, to be specific, appropriate some playback devices are selected according to the second relative location information about the target location and each of the first playback devices, and then the audio playback is performed by an array of the selected playback devices, to perform accurately playback the audio signal at the target location, which may accurately playback the audio signal at the location where the listener is, thus improving user experiences.

Optionally, in an embodiment of the present disclosure, the processing module is further configured to:
determine a target location, the target location being a location where a listener is when audio playback is performed;
select M first playback devices for audio playback from the N playback devices according to first relative location information between the target location and each of the playback devices, where M is a positive integer, M≤N;
determine second audio signals each corresponding to each of the first playback devices according to the first audio signal and second relative location information between the target location and each of the first playback devices; and
transmit each of the second audio signals to the corresponding first playback device to perform the audio playback.

Optionally, in an embodiment of the present disclosure, the first relative location information includes at least one of:
distance information between the target location and the playback device;
orientation angle information between the target location and the playback device, the orientation angle information including pitch angle information and/or azimuth angle information; or
information about an obstacle between the target location and the playback device.

Optionally, in an embodiment of the present disclosure, the second relative location information includes at least one of:
distance information between the target location and the playback device; or
orientation angle information between the target location and the playback device, the orientation angle information including pitch angle information and/or azimuth angle information.

Optionally, in an embodiment of the present disclosure, the signal processing device is in a vehicle, and the N playback devices are arranged on an inner wall of a vehicle body.

Optionally, in an embodiment of the present disclosure, the signal processing device is a vehicle-mounted signal processing device.

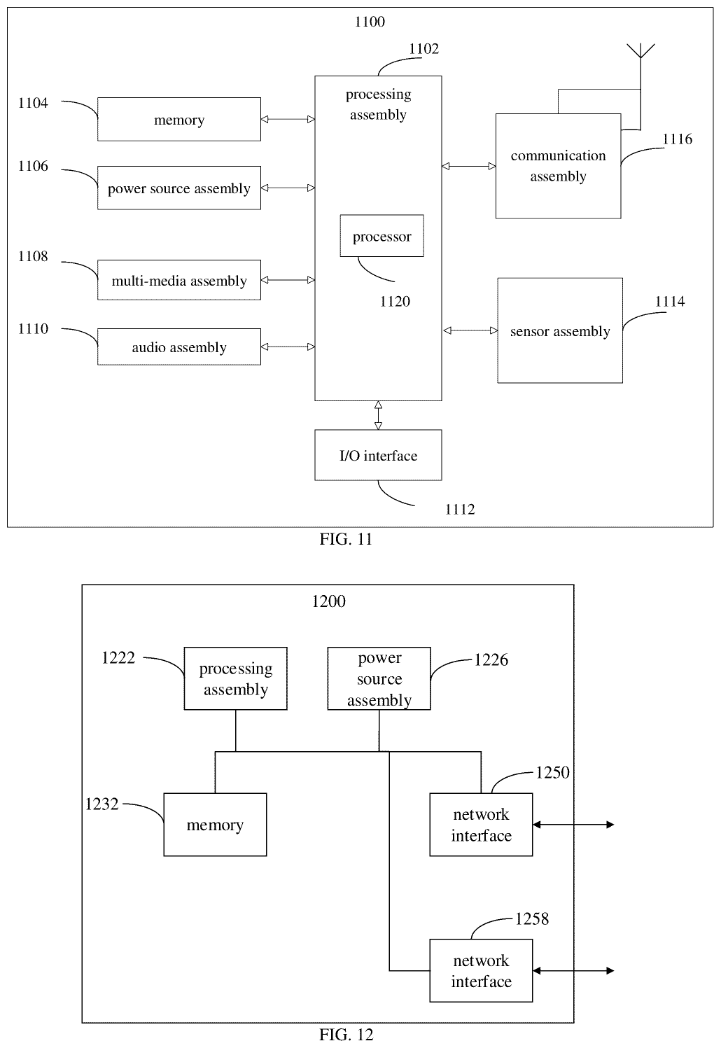

FIG. 11 is a block diagram of a user equipment (UE) 1100 according to the embodiments of the present disclosure. For example, the UE 1100 is a mobile phone, a computer, a digital broadcasting terminal device, a message transceiver device, a game console, a flat-panel device, medical equipment, fitness equipment, or a personal digital assistant.

As shown in FIG. 11, the UE 1100 includes at least one assembly: a processing assembly 1102, a memory 1104, a power source assembly 1106, a multi-media assembly 1108, an audio assembly 1110, an Input/Output (I/O) interface 1112, a sensor assembly 1113, and a communication assembly 1116.

Generally, the processing assembly 1102 controls an entire operation of the UE 1100, e.g., operations associated with display, phone call, data communication, camera operation and recording operation. The processing assembly 1102 includes at least one processor 1120 to execute an instruction, so as to implement all of, or a part of, the steps of the above-mentioned method. In addition, the processing assembly 1102 includes at least one module for the interaction between the processing assembly 1102 and the other assembly. For example, the processing assembly 1102 includes a multi-media module for the interaction between the multi-media assembly 1108 and the processing assembly 1102.

The memory 1104 is configured to store therein various types of data to support the operation of the UE 1100. Examples of such data include instructions for any application or method operated on the UE 1100, contact person data, phonebook data, messages, pictures, video, etc. The memory 1104 may be implemented in the form of any type of volatile or non-volatile memory devices, or a combination thereof, such as a Static Random-Access Memory (SRAM), an Electrically-Erasable Programmable Read Only Memory (EEPROM), an Erasable Programmable Read Only Memory (EPROM), a Programmable Read Only Memory (PROM), a Read Only Memory (ROM), a magnetic memory, a flash memory, a magnetic disk, or an optical disk.

The power source assembly 1106 provides power to various assemblies of the UE 1100. The power source assembly 1106 may include a power management system, one or more power sources, and any other assemblies associated with the generation, management and distribution of power in the UE 1100.

The multi-media assembly 1108 includes a screen for providing an output interface between the UE 1100 and a user. In some embodiments of the present disclosure, the screen may include a Liquid Crystal Display (LCD) and a Touch Panel (TP). When the screen includes the touch panel, the screen may be implemented as a touch screen to receive input signals from the user. The touch panel includes at least one touch sensor to sense touches, swipes, and gestures on the touch panel. The touch sensor may not only sense a boundary of a touch or swipe action, but also sense a period of time and a pressure associated with the touch or swipe action. In some embodiments of the present disclosure, the multi-media assembly 1108 includes a front-facing camera and/or a rear-facing camera. When the UE 1100 is in an operating mode, such as a shooting mode or a video mode, the front-facing camera and/or the rear-facing camera may receive external multi-media data. Each of the front-facing camera and the rear-facing camera may be a fixed optical lens system or has focal length and optical zoom capability.

The audio assembly 1110 is configured to output and/or input audio signals. For example, the audio assembly 1110 includes a microphone (MIC) configured to receive an external audio signal when the UE 1100 is in an operating mode, such as a call mode, a recording mode, and a voice recognition mode. The received audio signal may be further stored in the memory 1104 or transmitted via the communication assembly 1116. In some embodiments of the present disclosure, the audio assembly 1110 further includes a speaker to output audio signals.

The I/O interface 1112 provides an interface between the processing assembly 1102 and peripheral interface modules, such as a keyboard, a click wheel, buttons, and the like. The buttons may include, but not limited to, a home button, a volume button, a starting button, and a locking button.

The sensor assembly 1113 includes one or more sensors to provide status assessments about various aspects of the UE 1100. For example, the sensor assembly 1113 may detect an on/off status of the UE 1100, relative positioning of assemblies, e.g., the display and the keypad, of the UE 1100, a change in a location of the UE 1100 or an assembly of the UE 1100, a presence or absence of user contact with the UE 1100, an orientation or an acceleration/deceleration of the UE 1100, and a change in a temperature of the UE 1100. The sensor assembly 1113 may include a proximity sensor configured to detect the presence of nearby objects without any physical contact. The sensor assembly 1113 may also include a light sensor, such as a Complementary Metal Oxide Semiconductor (CMOS) or Charge-Coupled Device (CCD) image sensor, for use in imaging applications. In some embodiments of the present disclosure, the sensor assembly 1113 may also include an accelerometer sensor, a gyroscope sensor, a magnetic sensor, a pressure sensor, or a temperature sensor.

The communication assembly 1116 is configured to facilitate wired or wireless communication between the UE 1100 and other devices. The UE 1100 may access a wireless network based on a communication standard, such as Wi-Fi, 2G or 3G, or a combination thereof. In an exemplary embodiment of the present disclosure, the communication assembly 1116 receives a broadcast signal or broadcast associated information from an external broadcast management system via a broadcast channel. In an exemplary embodiment of the present disclosure, the communication assembly 1116 further includes a Near Field Communication (NFC) module to facilitate short-range communication. For example, the NFC module may be implemented based on a RF Identification (RFID) technology, an Infrared Data Association (IrDA) technology, an Ultra-Wide Band (UWB) technology, a Blue Tooth (BT) technology, and other technologies.

In the exemplary embodiment of the present disclosure, the UE 1100 may be implemented with one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, for performing the above-mentioned method.

FIG. 12 is a block diagram of a network side device 1200 according to the embodiments of the present disclosure. For example, the network side device 1200 is provided as a network side device. As shown in FIG. 12, the network side device 1200 includes a processing assembly 1222, which further includes at least one processor and memory resources represented by a memory 1232 for storing therein instructions to be executed by the processing assembly 1222, e.g., applications. The applications stored in the memory 1232 may include one or more modules each corresponding to one group of instructions. In addition, the processing assembly 1210 is configured to execute the instructions, so as to implement any method for the network side device, e.g., the method in FIG. 1.

The network side device 1200 further includes a power source assembly 1226 configured to performed power management over the network side device 1200, a wired or wireless network interface 1250 configured to couple the network side device 1200 to a network, and an Input/Output (I/O) interface 1258. The network side device 1200 may be based on an operating system stored in the memory 1232, e.g., Windows Server TM, Mac OS XTM, Unix TM, Linux TM, Free BSDTM, or the like.

In the above-mentioned embodiments of the present disclosure, the methods have been described from the perspectives of the network side device and the UE. In order to achieve various functions in the embodiments of the present disclosure, each of the network side device and the UE includes a hardware structure and a software module, i.e., the functions are achieved in the form of the hardware structure, the software module, or the combination thereof. A certain function in these functions is executed through the hardware structure, the software module, or the combination thereof.

In the above-mentioned embodiments of the present disclosure, the methods have been described from the perspectives of the network side device and the UE. In order to achieve various functions in the embodiments of the present disclosure, each of the network side device and the UE includes a hardware structure and a software module, i.e., the functions are achieved in the form of the hardware structure, the software module, or the combination thereof. A certain function in these functions is executed through the hardware structure, the software module, or the combination thereof.

The present disclosure further provides in some embodiments a communication apparatus, which includes a transceiver module and a processing module. The transceiver module includes a transmitting module and/or a receiving module, the transmitting module is configured to achieve a transmitting function, the receiving module is configured to achieve a receiving function, and the transceiver module is configured to achieve the transmitting function and/or the receiving function.

The communication apparatus may be a terminal device (e.g., the terminal device mentioned hereinabove), or an apparatus in the terminal device, an apparatus capable of being used in combination with the terminal device. Alternatively, the communication apparatus may be a network device, an apparatus in the network device, or an apparatus capable of being used in combination with the network device.

The present disclosure further provides in some embodiments another communication apparatus. The communication apparatus may be a network device, a terminal device (e.g., the terminal device mentioned hereinabove), or a chip, a chip system or a processor which supports the network device to achieve the above-mentioned method, or a chip, a chip system or a processor which supports the terminal device to achieve the above-mentioned method. The apparatus is used to achieve the above-mentioned method, which will not be particularly defined herein.

The communication apparatus may include one or more processors. The processor may be a general-purpose processor or special-purpose processor, e.g., a baseband processor or a Central Processing Unit (CPU). The baseband processor is configured to process a communication protocol as well as communication data, and the CPU is configured to control the communication apparatus (e.g., a network side device, a baseband chip, a terminal device, a terminal device chip, a Distributed Unit (DU) or a Centralized Unit (CU)), execute a computer program, and process data in the computer program.

Optionally, the communication apparatus further includes one or more memories storing therein a computer program. The computer program is executed by the processor, so that the communication apparatus executes the above-mentioned method. Optionally, the memory further stores therein data. The communication apparatus is arranged independent of, or integrated with, the memory.

Optionally, the communication apparatus further includes a transceiver and an antenna. The transceiver is also called as a transceiver unit, a transceiver machine or a transceiver circuit, and it is configured to achieve a transmitting function and a receiving function. The transceiver includes a receiver and a transmitter. The receiver is called as a receiving machine or a receiving circuit, and it is configured to achieve the receiving function. The transmitter is called as a transmitting machine or a transmitting circuit, and it is configured to achieve the transmitting function.

Optionally, the communication apparatus further includes one or more interface circuits. The interface circuit is configured to receive a code instruction and transmit it to the processor. The processor executes the code instruction, so that the communication apparatus implements the above-mentioned method.

The communication apparatus is a terminal device (e.g., the terminal device mentioned hereinabove), and the processor is configured to execute the method in FIGS. 1 to 4.

The communication apparatus is a network device, and the transceiver is configured to execute the method in FIGS. 5 to 7.

Optionally, the processor may include a transceiver for achieving a receiving function and a transmitting function. For example, the transceiver is a transceiver circuit, an interface, or an interface circuit. The transceiver circuit, the interface or the interface circuit for achieving the receiving function and the transmitting function may be arranged separately, or integrated with each other. The transceiver circuit, the interface or the interface circuit is configured to read and write codes/data, or transmit/or transfer signals.

Optionally, the processor stores therein a computer program, and the computer program is executed by the processor, so that the communication apparatus implements the above-mentioned method. The computer program may be programmed in the processor, and in this case, the processor may be implemented through hardware.

Optionally, the communication apparatus includes a circuit for implementing the above-mentioned transmitting, receiving or communication function. The processor and the transceiver described in the embodiments of the present disclosure may be implemented in an Integrated Circuit (IC), an analog IC, a Radio Frequency IC (RFIC), a mixed-signal IC, an Application Specific Integrated Circuit (ASIC), a Printed Circuit Board (PCB) or an electronic device. The processor and the transceiver may also be manufactured through various IC processes, e.g., Complementary Metal Oxide Semiconductor (CMOS), nMetal-oxide-semiconductor (NMOS), positive channel metal oxide semiconductor (PMOS), bipolar junction transistor (BJT), bipolar CMOS (BiCMOS), silicon germanium (SiGe), gallium arsenide (GaAs), etc.

The communication apparatus mentioned hereinabove may be a network device or a terminal device (e.g., the terminal device mentioned hereinabove), but the scope of the communication apparatus is not limited thereto. In addition, a structure of the communication apparatus will not be particularly defined herein. The communication apparatus may be an independent device, or a part of a large device. For example, the communication apparatus may be:
(1) an independent IC, chip, chip system or chip sub-system;
(2) a set of one or more ICs (optionally, the IC set also includes a memory member for storing therein data and a computer program;
(3) an ASIC, e.g., a Modem;
(4) a module capable of being embedded into the other device;
(5) a receiver, a terminal device, a smart terminal device, a cellular phone, a wireless device, a handheld device, a mobile unit, a vehicle-mounted device, a network device, a cloud device, an artificial intelligence device, etc.; or
(6) the other device.

When the communication apparatus is a chip or a chip system, the chip includes a processor and an interface. There may exist one or more processors, and one or more interfaces.

Optionally, the chip further includes a memory for storing therein necessary computer programs and data.

It should be appreciated that, various illustrative logical blocks and steps listed in the embodiments of the present disclosure may be implemented through electronic hardware, computer software, or a combination thereof. Whether these functions are implemented through hardware or software depends on design requirements on an entire system and specific applications. For each specific application, various methods are used to achieve the function, which however shall not be construed as going beyond the scope of the present disclosure.

The present disclosure further provides in some embodiments a system for determining a Sidelink duration. The system includes the communication apparatus serving as a terminal device (e.g., the first terminal device in the above-mentioned method embodiments) and the communication apparatus serving as a network device in the above-mentioned embodiments, or the communication apparatus serving as a terminal device (e.g., the first terminal device in the above-mentioned method embodiments) and the communication apparatus serving as a network device in the above-mentioned embodiments.

The present disclosure further provides a readable storage medium storing therein instructions. The instructions are executed by a computer so as to achieve the functions in any of the above-mentioned method embodiments.

The present disclosure further provides a computer program product. The computer program product is executed by a computer so as to achieve the functions in any of the above-mentioned method embodiments.

In the above-mentioned embodiments, all of, or a part of, the modules are implemented in the form of software, hardware, firmware or a combination thereof. When the modules are implemented in the form of software, all of, or a part of, the modules are implemented in the form of a computer program product. The computer program product includes one or more computer programs. When the computer programs are loaded onto and executed by a computer, all of, or a part of, the processes or functions in the embodiments of the present disclosure are generated by the computer. The computer may be a general-purpose computer, a special-purpose computer, a computer network, or any other programmable device. The computer program may be stored in a computer-readable storage medium, or transferred from one computer-readable storage medium to another computer-readable storage medium, e.g., transferred from one website, one computer, one server or one data center to another website, another computer, another server or another data center in a wired manner (e.g., through a co-axial cable, an optical fiber, or a digital subscriber line (DSL)) or a wireless manner (e.g., infrared, cordless or microwave). The computer-readable storage medium may be any available medium capable of being accessed by a computer, or a data storage device, e.g., a server or a data center including one or more available mediums. The available medium may be a magnetic medium (e.g., a floppy disc, a hard disc or magnetic tape), an optical medium (e.g., a digital video disc (DVD)), or a semiconductor medium (e.g., a solid state disk (SSD)).

Those skilled in the art should be appreciated that, such words as “first” and “second” are used to differentiate the items from each other, but shall not be construed as limiting the scope of embodiments of the present disclosure or indicating any sequence.

The expression “at least one” is used to indicate one or more, e.g., two, three, four or more, which will not be particularly defined herein. In the embodiments of the present disclosure, for technical features of a same kind, the words “first”, “second”, “third”, “A”, “B”, “C” and “D” are used to differentiate these technical features, without indicating any sequence or sizes thereof.

Other embodiments of the present disclosure will be apparent to those skilled in the art by considering of the specification and practice of the present disclosure disclosed here. The present disclosure is intended to cover any variations, uses, or modification of the disclosure following the general principles thereof and including common knowledge and conventional technical means which are not disclosed by the present disclosure. It is intended that the specification and examples be considered as exemplary only, with a true scope and spirit of the disclosure being indicated by the appended claims.

It should be appreciated that, the present disclosure is not limited to the exact construction that has been described hereinabove and illustrated in the accompanying drawings, and that various modifications and changes can be made without departing from the scope thereof. It is intended that the scope of the present disclosure only be limited by the appended claims.

1. An audio playback method, performed by a reception end, wherein N playback devices are arranged in a periphery of the reception end, N is a positive integer, and the method comprises:
receiving an audio stream from a transmission end, and decoding the audio stream to obtain a first audio signal decoded; and
processing the first audio signal according to the N playback devices, to perform audio playback by the playback device.

2. The method of claim 1, wherein processing the first audio signal to perform audio playback by the playback device comprises:
determining a target location, wherein the target location is a location where a listener is in a case that the audio playback is performed;
selecting M first playback devices for audio playback from the N playback devices based on first relative location information between the target location and each of the N playback devices, where M is a positive integer, M≤N;
determining second audio signals each to each of the M first playback devices based on the first audio signal and second relative location information between the target location and each of the M first playback devices; and
transmitting each of the second audio signals to the first playback device corresponding to the second audio signal, to perform the audio playback.

3. The method of claim 1, wherein processing the first audio signal to perform the audio playback by the playback device comprises:
transmitting the first audio signal to a signal processing device, to enable the signal processing device to process the first audio signal according to the N playback devices to obtain a second audio signal and play back the second audio signal by the playback device.

4. The method of claim 2, wherein the first relative location information comprises at least one of:
distance information between the target location and the playback device;
orientation angle information between the target location and the playback device, wherein the orientation angle information comprises pitch angle information and/or azimuth angle information; or
information about an obstacle between the target location and the playback device.

5. The method of claim 2, wherein the second relative location information comprises at least one of:
distance information between the target location and the playback device; or
orientation angle information between the target location and the playback device, wherein the orientation angle information comprises pitch angle information and/or azimuth angle information.

6. The method of claim 1, wherein the reception end is in a vehicle, and the N playback devices are arranged on an inner wall of the vehicle.

7. The method of claim 6, wherein the reception end is a vehicle-mounted communication device.

8. The method of claim 6, wherein the reception end is a mobile terminal in the vehicle.

9. The method of claim 2, wherein:
the reception end is in a vehicle, and the N playback devices are arranged on an inner wall of the vehicle, and
determining the target location comprises:
obtaining the target location predetermined, wherein the target location is any location in the vehicle.

10. The method of claim 2, wherein:
the reception end is a mobile terminal in the vehicle, and the N playback devices are arranged on an inner wall of the vehicle; and
the determining the target location comprises:
determining a location of the mobile terminal as the target location.

11. The method of claim 7, wherein the signal processing device is a vehicle-mounted signal processing device.

12. An audio playback method, performed by a signal processing device, wherein N playback devices are arranged in a periphery of the signal processing device, N is a positive integer, the audio playback method comprises:
obtaining a first audio signal from a reception end; and
processing the first audio signal according to the N playback devices, to perform audio playback by the playback device.

13. The method of claim 12, wherein processing the first audio signal to perform the audio playback by the playback device comprises:
determining a target location, wherein the target location is a location where a listener is in a case that the audio playback is performed;
selecting M first playback devices for audio playback from the N playback devices based on first relative location information between the target location and each of the N playback devices, where M is a positive integer, M≤N;
determining second audio signals each corresponding to each of the M first playback devices based on the first audio signal and second relative location information between the target location and each of the M first playback devices; and
transmitting each of the second audio signals to the first playback device corresponding to the second audio signal, to perform the audio playback.

14. The method of claim 13, wherein the first relative location information comprises at least one of:
distance information between the target location and the playback device;
orientation angle information between the target location and the playback device, wherein the orientation angle information comprises pitch angle information and/or azimuth angle information; or
information about an obstacle between the target location and the playback device.

15. The method of claim 13, wherein the second relative location information comprises at least one of:
distance information between the target location and the playback device; or
orientation angle information between the target location and the playback device, wherein the orientation angle information comprises pitch angle information and/or azimuth angle information.

16. The method of claim 12, wherein the signal processing device is in a vehicle, and the N playback devices are arranged on an inner wall of the vehicle.

17. The method of claim 16, wherein the signal processing device is a vehicle-mounted signal processing device.

18.-19. (canceled)

20. A reception end, N playback devices being arranged in a periphery of the reception end, where N is a positive integer, the receiving side device being configured to:
receive an audio stream from a transmission end, and decode the audio stream to obtain a first audio signal decoded; and
process the first audio signal according to the N playback devices, to perform audio playback by the playback device.

21. A signal processing device, N playback devices being arranged in a periphery of the signal processing device, where N is a positive integer, the signal processing device being configured to implement the audio playback method of claim 12.

22.-23. (canceled)

24. A computer-readable storage medium storing therein instructions, wherein when the instructions are executed, the method of any one of claim 1 is implemented.

25. (canceled)
